(19) United States
(12) Patent Application Publication
(10) Pub. No.: US 2024/0294761 A1
(43) Pub. Date: Sep. 5, 2024

(54) DUAL CURE ORGANOPOLYSILOXANE COMPOSITION WITH SHELF-LIFE STABILITY

(71) Applicants: Dow Silicones Corporation, Midland, MI (US); Dow Global Technologies LLC, Midland, MI (US)

(72) Inventors: Junying Liu, Midland, MI (US); Shuangbing Han, Midland, MI (US)

(21) Appl. No.: 18/261,741

(22) PCT Filed: Feb. 25, 2022
(86) PCT No.: PCT/US2022/017796

§ 371 Date: Jul. 17, 2023

Related U.S. Application Data
(60) Provisional application No. 63/173,534, filed on Apr. 12, 2021.

(51) Int. Cl. C08L 83/06; C08G 77/28; C08K 5/5397

(52) U.S. Cl. CPC C08L 83/06; C08G 77/28; C08K 5/5397; C08L 2205/03

(57) ABSTRACT

A dual cure organopolysiloxane composition contains: (a) a first organopolysiloxane comprising an average of 2 or more mercaptoalkyl groups per molecule and that is free of alkenyl functionality; (b) a second organopolysiloxane comprising an average of one or more alkenyl group per molecule and an average of one or more hydrolysable group per molecule; (c) optionally, a third organopolysiloxane having at least two alkenyl groups per molecule and that is free of alkoxy groups; (d) a bisacylphosphine oxide photoinitiator; (c) optionally, a carrier liquid; (f) a condensation catalyst; (f) a silane with an average of 2 or more hydrolysable groups per molecule; and (h) a radical scavenger.

### FIELD OF THE INVENTION

The present invention relates to an organopolysiloxane composition capable for both ultra-violet (UV) and moisture induced curing.

### INTRODUCTION

Organopolysiloxane systems that can undergo dual curing, curing by two different mechanisms, are increasingly popular. In particular, organopolysiloxane systems that undergo ultraviolet (UV) curing as well as moisture curing are useful in many applications. The UV light curing aspect of the composition provides for a rapid initial curing of the composition to facilitate continued process or handling without damage to the coating for those areas of the composition that can be exposed to UV light. The moisture cure mechanism serves to cure composition blocked from exposure to light (“shadow areas”) as well as cure the composition more completely over time. One type of UV/moisture dual cure system uses thiol-ene chemistry for the UV curing. Thiol-ene curing is desirable over (meth)acrylate-photocuring mechanisms because the thiol-ene is not oxygen sensitive like the (meth)acrylate materials. Thiol-ene systems have thiol-containing organopolysiloxanes that react with carbon-carbon double bonds (alkenes) in other components of the reactive system upon exposure to UV light to result in chemical crosslinking, or curing. Dual cure systems utilizing thiol-ene chemistry typically comprise thiol-containing organopolysiloxane and unsaturated organopolysiloxane reactants.

Thiol-ene-based UV and moisture dual cure systems tend to suffer from relatively short shelf-life compared with moisture-cure only systems or thiol-ene UV cure only siloxane systems. Shelf-life can be evaluated by determining if a composition experiences an increase in viscosity and/or decrease in cure depth upon UV cure and/or increase in time to tack-free surface by moisture curing after storage relative to when the composition is freshly made.

WO2020/076620 attempts to address the problem of shelf-life for thiol-ene based dual cure formulations by providing a thiol-ene dual cure organopolysiloxane system that requires an epoxy compound to stabilize the formulation.

It is desirable to identify a dual curing polyorganosiloxane system that undergoes moisture cure and thiol-ene UV curing that also achieves shelf stability without requiring an epoxy compound, where shelf stability is characterized by being able to be aged 21 days in the dark at 55 degrees Celsius (C) in a syringe within a vacuum sealed aluminum bag to preclude moisture while afterwards:
(1) experiencing an increase in viscosity of less than 2-times its fresh viscosity as measured according to ASTM D-1084 using by a Brookfield DVII+P viscometer with a cone spindle CPA-52Z according to ASTM D-1084 at 23+/−2° C.; and
(2) experiencing a cure depth of at least 70%, preferably 80% or more, more preferably 90% or more relative to a freshly made identical composition when exposed to 2 Joules per square centimeter (J/cm²) UVA and UVB irradiation, and desirably also achieve a cure depth of at least 8 millimeters (mm) before and after aging; and
(3) experiencing a moisture cure tack-free time of 24 hours or less.

### BRIEF SUMMARY OF THE INVENTION

The present invention provides a dual curing polyorganosiloxane system that undergoes moisture cure and thiol-ene UV curing that also has shelf stability without requiring an epoxy compound, where shelf stability is characterized by being able to be aged 21 days in the dark at 55 degrees Celsius (° C.) in a vacuum to preclude moisture while afterwards:
(1) experiencing an increase in viscosity of less than 2-times its fresh viscosity as measured according to ASTM D-1084 using by a Brookfield DVII+P viscometer with a cone spindle CPA-52Z according to ASTM D-1084 at 23+/−2° C.; and
(2) experiencing a cure depth of at least 70%, preferably 80% or more, more preferably 90% or more relative to a freshly made identical composition when exposed to 2 Joules per square centimeter (J/cm²) UVA and UVB irradiation, and can even achieve a cure depth of at least 8 mm before and after aging; and
(3) experiencing a moisture cure tack-free time of 24 hours or less.

Surprisingly, it has been discovered that including diacylphosphine oxide photoinitiator in the dual curing polyorganosiloxane system results in a shelf-stable dual cure system meeting these aforementioned requirements.

In a first aspect, the present invention is a dual cure organopolysiloxane composition comprising: (a) a first organopolysiloxane comprising an average of 2 or more mercaptoalkyl groups per molecule and that is free of alkenyl functionality; (b) a second organopolysiloxane comprising an average of one or more alkenyl group per molecule and an average of one or more hydrolysable group per molecule; (c) optionally, a third organopolysiloxane having at least two alkenyl groups per molecule and that is free of alkoxy groups; (d) a bisacylphosphine oxide photoinitiator; (e) optionally, a carrier liquid; (f) a condensation catalyst; (f) a silane with an average of 2 or more hydrolysable groups per molecule; and (h) a radical scavenger.

The composition of the present invention is useful as a dual cure polyorganosiloxane system.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; END refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

“Liquid” means free flowing at 25 degrees Celsius (° C.).

“Polar liquid” refers to a liquid capable of dissolving polar substances. For avoidance of doubt, toluene is not considered a polar liquid.

“Hydrolysable group” refers to a group that, when attached to a silicon atom, can form a silanol in water. Hydrolysable groups include alkoxy, oximino, acetoxy and amino groups.

“Organopolysiloxane” is a polysiloxane that has at least one organic group bound to the polysiloxane backbone.

“Polysiloxane” is a polymer comprising multiple siloxane units bound to one another to form a siloxane backbone. Unless otherwise stated, the siloxane units can be selected from “M”-type siloxane units having a chemical structure of: R′₃SiO_{1/2}; “D”-type siloxane units having a chemical structure of: R′₂SiO_{2/2}; “T”-type siloxane units having a chemical structure of: R′SiO_{3/2}; and “Q”-type siloxane units having a chemical structure of: SiO_{4/2}, where in each occurrence R′ can be any group, but is generally selected from hydrogen, hydroxyl, alkoxyl, mercapto, amino, hydrocarbyl, and substituted hydrocarbyl groups. The oxygen atom with a multiple of “1/2” subscript in a specific siloxane unit designates an oxygen atom shared with another silicon atom of the siloxane backbone, where the numerator indicates how many shared oxygen atoms are bound to the silicon atom of the specific siloxane unit.

The present invention is a dual cure organopolysiloxane composition. “Dual cure” means that the organopolysiloxane components of the composition can undergo crosslinking reactions either by exposure to ultraviolet (UV) light or exposure to moisture. The UV light triggered crosslinking reaction is a “thiol-ene” reaction between the thiol functionality of a mercaptoalkyl group and an alkene functionality. The moisture triggered crosslinking reaction is between hydrolysable groups on different molecules.

The dual cure organopolysiloxane composition comprises a first organopolysiloxane that contains an average of 2 or more, and can contain 3 or more, 4 or more, even 5 or more while at the same time generally contains 20 or fewer, 15 or fewer, 10 or fewer, 8 or fewer, even 6 or fewer mercaptoalkyl groups per molecule and that is free of alkenyl functionality. Desirably, the first organopolysiloxane consists of M-type and D-type siloxane units. For instance, one desirably first organopolysiloxane is a linear organopolysiloxane having chemical structure (I):

(R¹₂R³SiO_{1/2})₂(R¹R²SiO_{2/2})ₘ(R¹₂SiO_{2/2})ₙ (I)
where:

R¹ is independently, in each occurrence, a hydrocarbyl or substituted hydrocaryl group having one or more, and can have 2 or more, 3 or more, 4 or more, 5 or more, 6 or more, 7 or more, even 8 or more while at the same time generally has 20 or fewer, 18 or fewer, 16 or fewer, 14 or fewer, 12 or fewer, 10 of fewer, 8 or fewer, 6 or fewer, 4 or fewer, even 2 or fewer carbon atoms. Examples of suitable R¹ groups include methyl, ethyl, phenyl and 3,3,3-trifluoropropyl groups. Preferably, R¹ is a methyl group.

R² is independently, in each occurrence, a mercaptoalkyl group. “Mercaptoalkyl group” refers to a —R—SH group, where R is a divalent hydrocarbon, preferably a divalent hydrocarbon having one or more, preferably 2 or more and can have 3 or more, 4 or more, 5 or more, 6 or more, 7 or more, 8 or more, 9 or more, 10 or more, 12 or more, 14 or more, 16 or more, even 18 or more carbon atoms while at the same time generally has 20 or fewer, or even 18 or fewer, 16 or fewer, 14 or fewer, 12 or fewer, 10 or fewer, 8 or fewer, 6 or fewer, 4 or fewer, even 2 or fewer carbon atoms. The R group can be linear or branched. For example, R² can be selected from —CH₂SH, —CH₂CH₂SH, —CH₂(CH₂)₂SH, and —CH₂(CH₂)₃SH.

R³ is independently in each occurrence selected from the options for R¹ and R².

Subscript m has an average value of 2 or more, and can be 3 or more, 4 or more, 5 or more, 10 or more, 20 or more 30 or more, 40 or more, 50 or more, 60 or more, 70 or more, 80 or more, 90 or more, 100 or more, 200 or more, 300 or more, 400 or more, even 500 or more while at the same time is generally 1000 or less, 750 or less, 500 or less, 250 or less, 100 or less, 75 or less, 50 or less, 20 or less, 15 or less, 10 or less, 8 or less, even 6 or less.

Subscript n has an average value of zero or more, one or more, and can be 5 or more, 10 or more, 15 or more, 20 or more, 25 or more, 30 or more, 35 or more, 40 or more, 43 or more, 45 or more, even 50 or more, 100 or more, 200 or more, 300 or more, 400 or more, even 500 or more while at the same time is generally 1000 or less, 750 or less, 500 or less, 250 or less, 100 or less, 90 or less, 80 or less, 70 or less, 60 or less, 50 or less, even 45 or less.

One desirable first organopolysiloxane has a chemical structure of formula (I) where R¹ is methyl, R² is —CH₂(CH₂)₂SH and the average value for m is 5 and the average value for n is 43.

Desirably, the first organopolysiloxane is present at a concentration that is sufficient to provide a molar ratio of mercaptoalkyl groups from the first organopolysiloxane to alkenyl groups from the second organopolysiloxane and, if present, third organopolysiloxane that is 0.3 or more, and can be 0.5 or more, 1.0 or more, 1.5 or more, 2.0 or more, 2.5 or more, 3.0 or more, 3.5 or more, 4.0 or more, even 4.5 or more while at the same time is generally 5.0 or less, 4.5 or less, 4.0 or less, 3.5 or less, 3.0 or less, 2.5 or less, 2.0 or less, 1.5 or less, even 1.0 or less. Determine the molar ratio of mercaptoalkyl groups to alkenyl groups from the components and formulation used to prepare the composition. If the formulation is unknown, determine the molar ratio of mercaptoalkyl groups to alkenyl groups using infrared spectroscopy, Raman spectroscopy and nuclear magnetic resonance (NMR) spectroscopy.

The composition of the present invention also comprises a second organopolysiloxane. The second organopolysiloxane comprises an average of one or more, and can comprise 2 or more, 3 or more, 4 or more, 5 or more, even 6 or more and generally comprises 20 or fewer, 15 or fewer, 10 or fewer, even 5 or fewer, 4 or fewer, 3 or fewer, or 2 or fewer alkenyl groups per molecule. Determine the average number of alkenyl groups per molecule from the material used as the second organopolysiloxane in preparing the composition. If the formulation is unknown, determine the average number of alkenyl groups per molecule using NMR spectroscopy. Desirably, the alkenyl group is a terminal alkenyl group, which means the carbon-carbon double bond (C═C) of the alkenyl group includes a terminal carbon of the alkenyl group. Preferably, the alkenyl group is a vinyl group.

The second organopolysiloxane also comprises an average of one or more, and can comprise 2 or more, 3 or more, 4 or more, 5 or more, even 6 or more and generally comprises 20 or fewer, 15 or fewer, 10 or fewer, even 5 or fewer, 4 or fewer, 3 or fewer, or 2 or fewer hydrolysable groups per molecule. Determine the average number of hydrolysable groups per molecule from the material used as the second organopolysiloxane in preparing the composition. If the formulation is unknown, determine the average number of hydrolysable groups per molecule using NMR spectroscopy. The hydrolysable group is desirably an alkoxy group, preferably an alkoxy group, that has the following chemical structure: —OR³, where R³ is an alkyl group having one or more, 2 or more, 3 or more, 4 or more, 5 or more, 6 or more, 7 or more, even 8 or more while at the same time typically has 10 or fewer, 8 or fewer, 6 or fewer, 4 or fewer, even 2 or fewer carbon atoms. Preferably, the alkoxy group is selected from methoxy, ethoxy and propoxy groups, more preferably the alkoxy group is a methoxy group. Preferably, the hydrolysable groups are bound to silicon atoms of an M-type and/or D-type siloxane unit in the second organopolysiloxane.

The second organopolysiloxane can comprise any combination of M-type, D-type, T-type and Q-type siloxane units. Desirably, the second organopolysiloxane has chemical structure (II):

(SiO_{4/2})ₓ(R^{a}₂SiO_{2/2})_{y}(R^{a}₂SiO_{2/2})_{y′}(R^{a}₂BSiO_{1/2})_{z} (II)
where:
   R^{a} is independently in each occurrence selected form alkyl and aryl groups;
   B is independently in each occurrence selected from alkenyl and alkoxy and alkoxy-containing groups so as to achieve an average of one or more alkenyl group and one or more alkoxy group per molecule;
   x is, on average, a value of zero or more and at the same time 10 or less;
   the sum of y and y′, on average, is a value of 20 or more while at the same time is 1000 or less; and
   z has, on average, a value of 2 or more and at the same time is 20 or less.

One suitable second organopolysiloxane has an average chemical structure of chemical structure (III):

Si[O—((CH₃)₂SiO)ₐ—Si(CH₃)₂—CH═CH₂]₂[O—[Si(CH₃)₂—O—]_{b}—Si(CH₃)₂—CH₂CH₂—Si(CH₃)₂—O—Si(CH₃)₂—CH₂CH₂—Si(OCH₃)₃]₂ (III)

where subscripts a and b are independently a value of 10 or more, 15 or more, 20 or more, 25 or more, 30 or more, 45 or more, 60 or more, 100 or more, even 500 or more while at the same time is generally 200 or less, 100 or less, 50 or less, 45 or less, 40 or less, 35 or less, and even 30 or less.

The composition of the present invention can further comprise a third organopolysiloxane. The third organopolysiloxane has 2 or more, 3 or more, 4 or more, 5 or more even 6 or more and generally comprises 20 or fewer, 15 or fewer, 10 or fewer, even 5 or fewer, 4 or fewer, 3 or fewer, or 2 or fewer alkenyl groups per molecule. Determine the average number of alkenyl groups per molecule from the material used as the third organopolysiloxane in preparing the composition. If the formulation is unknown, determine the average number of alkenyl groups per molecule using NMR spectroscopy. Desirably, the alkenyl group is a terminal alkenyl group. Preferably, the alkenyl group is a vinyl group.

The third organopolysiloxane desirably consists of M-type and D-type siloxane units. An example of a suitable third organopolysiloxane has chemical structure (IV):

(CH₃)₂ViSiO—[(CH₃)₂SiO]_{d}—Si(CH₃)₂Vi (IV)

where “Vi” refers to a vinyl group and subscript d generally has a value of 100 or more, 150 or more, 200 or more, 250 or more, 300 or more, 350 or more, 400 or more, 450 or more, 500 or more, 550 or more, 600 or more, 650 or more, 700 or more, even 750 or more, or 760 or more while as the same time typically has a value of 1000 or less, 950 or less, 900 or less, 850 or less, or even 800 or less, or 775 or less.

The third organopolysiloxane can be present in the composition at a concentration of zero weight-percent (wt %) or more, 10 wt % or more, 20 wt % or more, 30 wt % or more, 40 wt % or more, 50 wt % or more, 60 wt % or more, even 70 wt % or more while at the same time is typically present at a concentration of 80 wt % or less, and can be present at a concentration of 70 wt % or less, 60 wt % or less, 50 wt % or less, 40 wt % or less, 30 wt % or less, 20 wt % or less, even 10 wt % or less with wt % relative to the combined weight of second and third organopolysiloxanes.

The composition of the present invention further comprises a bisacylphosphine oxide photoinitiator. It has been surprisingly and unexpectedly discovered with the present invention that use of bisacylphosphine oxide as a photoinitiator results in greater shelf stability than similar compositions that do not contain bisacylphosphine oxide photoinitiators. Examples of suitable bisacylphosphine oxide photoinitiators include bis(2,4,6-trimethylbenzoyl)-phenylphosphine oxide, and bis(2,4,6-trimethylbenzoyl)-(2,4,4-trimethylpentyl) phenylphosphine oxide.

The bisacylphosphine oxide can be the only photoinitiator in the composition or there can be additional photoinitiators present. Examples of additional photoinitiators include any one or any combination of more than one selected from hydroxyacetophenones, aminoacetophenones, phosphine oxides, benzophenones, substituted benzophenones, and thioxanthones. Particularly desirable additional photoinitiators include 2-Hydroxy-2-methyl-1-phenyl-1-propanone, Ethyl (2,4,6-trimethylbenzoyl) phenyl phosphinate; 2,2-Dimethoxy-1,2-diphenylethan-1-one; 2,2-diethoxyacetophenone; 1-Hydroxy-cyclohexyl-phenyl-ketone. Particularly desirable additional photoinitiators are liquid photoinitiators. Liquid photoinitiators can be used as a carrier liquid for the composition. Examples of suitable liquid photoinitiators include 2-hydroxy-2-methyl propiophenone, ethyl (2,4,6-trimethylbenzoyl) phenyl phosphinate; and 2,2-diethoxyacetophenone.

The bisacylphosphine oxide photoinitiator, in combination with any additional photoinitiators, is desirably present at a concentration of 0.01 weight-percent (wt %) or more, 0.1 wt % or more, 0.5 wt % or more, 1.0 wt % or more, 2.0 wt % or more, 3.0 wt % or more, even 4.0 wt % or more while at the same time is generally 5.0 wt % or less and can be 4.0 wt % or less, 3.0 wt % or less, 2.0 wt % or less, even 1.0 wt % or less based on composition weight. Desirably, the bisacylphosphine oxide is 5 wt % or more, 10 wt % or more, 20 wt % or more, 40 wt % or more, 50 wt % or more, 60 wt % or more, 70 wt % or more, 80 wt % or more, even 90 wt % or more while at the same time is 100 wt % or less, and can be 90 wt % or less, 80 wt % or less, 70 wt % or less, 60 wt % or less, 50 wt % or less, 40 wt % or less, 30 wt % or less, even 20 wt % or less of the total weight of photoinitiator in the composition.

The composition optionally comprises a carrier liquid. A carrier liquid is desirable because it can serve to compatibilize the bisacylphosphine oxide with the organopolysiloxane components of the composition thereby enabling formation of a uniform composition. Generally, the bisacylphosphine oxide photoinitiator is mixed with a carrier liquid prior to mixing with the organopolysiloxane components when preparing the composition of the present invention. The carrier liquid can be or can comprise a liquid photoinitiator. Examples of liquid photoinitiators that can serve as the carrier liquid include 2-hydroxy-2-methyl propiophenone, ethyl (2,4,6-trimethylbenzoyl) phenyl phosphinate; and 2,2-diethoxyacetophenone. Likewise, the carrier fluid can comprise or consist of one or more than one liquid that is not a photoinitiator such as silanes including methyltrimethoxysilane, dimethyldimethoxy silane, phenyltrimethoxysilane, and phenylmethyldimethoxysilane. The liquid carrier can comprise or consist of one or more than one non-polar organic liquid such as toluene.

Carrier liquid is present in the composition at a concentration of 0 wt % or more, and can be present at a concentration of 0.005 wt % or more, 0.01 wt % or more, 0.05 wt % or more, 0.10 wt % or more, 0.25 wt % or more, 0.50 wt % or more, 0.75 wt % or more, 1.0 wt % or more, 1.5 wt % or more, 2.0 wt % or more 2.5 wt % or more, 3.0 wt % or more, 3.5 wt % or more, 4.0 wt % or more, or even 4.5 wt % or more while at the same time is typically present at a concentration of 5.0 wt % or less, 4.5 wt % or less. 4.0 wt % or less, 3.5 wt % or less, 3.0 wt % or less, 2.5 wt % or less, 2.0 wt % or less, 1.5 wt % or less, 1.0 wt % or less, 0.50 wt % or less, 0.25 wt % or less, 1.0 wt % or less, 0.05 wt % or less, or even 0.01 wt % or less based on composition weight.

The composition comprises a condensation catalyst. The condensation catalyst is typically a titanate, tin or zirconium based catalyst. Examples of suitable condensation catalysts include any one or any combination of more than one condensation catalyst selected from a group consisting of tetraisopropylorthotitanate, titanium (IV) n-butoxide, titanium (IV) t-butoxide, titanium (IV), titanium di(isopropoxy)bis(ethylacetoacetate), Tetrakis(trimethylsiloxy)titanium; titanium di(isopropoxy)bis(methylacetoacetate), zirconium (IV) isopropoxide, zirconium (IV) n-butoxide, zirconium (IV) t-butoxide, zirconium di(isopropoxy)bis(ethylacetoacetate), zirconium di(isopropoxy)bis(methylacetoacetate), zirconium di(isopropoxy)bis(acetylacetonate, dimethyltin dineodecanoate, dibutyltin dilaurate, dibutyltin dioctoates, and stannous octoate.

Typically, the concentration of condensation catalyst is 0.01 wt % or more, 0.05 wt % or more, 0.1 wt % or more, 0.5 wt % or more, 1.0 wt % or more, 1.5 wt % or more, 2.0 wt % or more, and even 3.0 wt % or more while at the same time is generally 5.0 wt % or less, 4.0 wt % or less, 3.0 wt % or less, 2.0 wt % or less or even 1.0 wt % or less relative to composition weight.

The composition comprises a silane with an average of 2 or more hydrolysable groups per molecule. The silane serves as a crosslinker. It can also serve as a carrier liquid and/or a reactive diluent. Desirably, the hydrolysable groups are alkoxy groups, more preferably the hydrolysable groups are alkoxy groups selected from a group consisting of methoxy, ethoxy, propoxy and butoxy. The silane can be a dialkoxy silane, a trialkoxy silane or a combination of dialkoxy and trialkoxy silanes. Most preferably, the silane is a trialkoxy silane.

The silane desirably has the following structure:

R³_{f}Si(OR³)_{4-f}

where subscript f is one, two or three (preferably one or two, most preferably one) and R³ is independently in each occurrence selected from a group consisting of methyl, ethyl, propyl and butyl groups. Examples of suitable silane compounds include any one or combination of more than one selected from methyltrimethoxy silane, ethyltriethoxy silane, and dimethyldimethoxy silane.

The composition of the present invention can contain 0.05 wt % or more, 0.5 wt % or more, one wt % or more, 2 wt % or more, 3 wt % or more, 4 wt % or more, 5 wt % or more, 6 wt % or more, 7 wt % or more 8 wt % or more, 9 wt % or more, even 10 wt % or more while at the same time typically contains 20 wt % or less, 19 wt % or less, 18 wt % or less, 17 wt % or less, 16 wt % or less, 15 wt % or less, 14 wt % or less, 13 wt % or less, 12 wt % or less, 11 wt % or less or 10 wt % or less of the alkoxy silane compound based on composition weight.

The composition further comprises a radical scavenger (inhibitor) to inhibit radical reactions during storage to help increase storage stability of the composition. Examples of suitable radical scavengers include any one or any combination of more than one of butylated hydroxytoluene (BHT), 4-methoxyphenol, and tert-butylhydroquinone, 6-tert-butyl-2,4-xylenol, 2-tert-butyl-1,4-benzoquinone, 4-tert-butylpyrocatechol, 2,6-di-tert-butylphenol, and N-Nitroso-N-phenylhydroxyamine Aluminum salt. The radical scavenger is typically present at a concentration of 0.001 wt % or more, 0.005 wt % or more, 0.01 wt % or more, 0.05 wt % or more, 0.10 wt % or more, 0.50 wt % or more, 1.0 wt % or more, even 1.5 wt % or more while at the same time is typically present at a concentration of 2.0 wt % or less, 1.5 wt % or less, 1.0 wt % or less, even 0.5 wt % or less based on composition weight.

The composition can include additional components such as fillers. Examples of suitable fillers include silica such as fumed silica and quartz. Filler can be present at a concentration of zero wt % or more, one wt % or more, 5 wt % or more, 10 wt % or more, 15 wt % or more, even 20 wt % or more while at the same time are typically present at a concentration of 30 wt % or less, 20 wt % or less, 10 wt % or less or even 5 wt % or less with wt % relative to composition weight.

### Examples

Table 1 lists the components for use in the following examples.

TABLE 1

| Material | Description | Source |
|---|---|---|
| First | Dimethylsiloxane methyl(3- | Prepare according to |
| Organopolysiloxane | mercaptopropyl)siloxane copolymer having | procedures taught in |
| | the following chemical structure: | U.S. Pat. No. 4,780,486a |
| | (R₂R″SiO_{1/2})₂(RR′SiO_{2/2})ₘ(R₂SiO_{2/2})ₙ | |
| | where R═R″ = methyl, R′ = HS(CH₂)₂CH₂—, | |
| | and on average n = 43 and m = 5. | |
| Second | Vinyl and alkoxysilyl functional | Prepare according to the |
| Organopolysiloxane | dimethylpolysiloxane having the chemical | teachings in |
| | structure: | WO2020/076620A1. |
| | Si[O—(Si (CH₃)₂O)₃₀—Si(CH₃)₂—CH═CH₂]₂ | |
| | [O—[Si(CH₃)₂O]₃₀—Si(CH₃)₂—CH₂CH₂— | |
| | Si(CH₃)₂—O— Si(CH₃)₂—CH₂CH₂—Si(OCH₃)₃]₂ | |
| Third | Vinyl-functional dimethylpolysiloxane | Available under the name |
| Organopolysiloxane | having the chemical structure: | XIAMETER ™ RBL-2198 |
| | (CH₃)₂ViSiO—[(CH₃)₂SiO]₇₆₆—Si(CH₃)₂Vi | from the Dow Chemical |
| | | Company |
| Photoinitiator 1 | 2-hydroxy-2-methylpropiophenone | Commercially available under |
| (liquid | | the name OMNIRAD ™ 1173 |
| photoinitiator) | | from IGM Resins |
| Photoinitiator 2 | 2,4,6-Trimethylbenzoyldi- | Commercially available under |
| (monoacylphosphine | Phenylphosphinate | the name OMNIRAD TPO-L |
| oxide) | | from IGM Resins |
| Photoinitiator 3 | 2,2-Dimethoxy-1,2-diphenylethan-1-one | Commercially available under |
| | | the name OMNIRAD ™ BDK |
| | | from IGM Resins |
| Photoinitiator 4 | Bis(2,4,6-trimethylbenzoyl)- | Commercially available under |
| (bisacylphosphine | phenylphosphine oxide | the name OMNIRAD ™ 819 |
| oxide) | | from IGM Resins |
| Carrier Liquid 1 | Toluene | Sigma-Aldrich |
| Condensation | titanium ethyl acetoacetate complex mixed | Available under the name |
| Catalyst 1 | with a methyl-trimethoxy silane. | TYZOR ™ PITA-SM from |
| | | Dorf Ketal. |
| Condensation | Tetra-t-butyl titanate | Sigma Aldrich |
| Catalyst 2 | | |
| Condensation | Tetrakis(trimethylsiloxy)titanium | Gelest |
| Catalyst 3 | | |
| Silane | Methyltrimethoxysilane | Sigma-Aldrich |
| Radical Scavenger | Butylated hydroxytoluene (BHT) | Sigma-Aldrich |
| Filler | Fumed Silica that has been treated with | Available as TS-530 from |
| | hexamethyldisilazane. | Cabot. |

IRGACURE is a trademark of BASF SE Company. OMNIRAD is a trademark of IGM Group B.V. XIAMETER is a trademark of Dow Corning Corporation. TYZOR is a trademark of E.I. DuPont De Nemours and Company.

### Procedures

Aging. To age samples, package the sample in a 30 milliliter (mL) EFD syringe barrels and deair by centrifuging the sample in the syringe and then pushing the plunger to expel air, then seal the syringe in a vacuum sealed aluminum bag to preclude moisture and light. Place the bag with the sample into a preheated oven at 55° C. for 21 days.

UV Cure Depth Measurement. Determine UV cure depth for samples by filling a 2.54-millimeter diameter by 20-millimeter-deep void in a polytetrafluoroethylene block with sample and then exposing the sample to UVA and UVB light using a mercury lamp and Colight UV equipment with an exposure of 300 milliwatts per square centimeter and 2 Joules per square centimeter dosage. Remove the sample material from the polytetrafluoroethylene block, wipe away uncured sample and then measure the thickness of the solid cured sample using a ruler to determine how deep the sample was cured.

Moisture Cure Time to “Tack-Free”. Draw down a 1.27 millimeter (50 mill) thick film of sample onto an FR4 board. Moisture cure the film by allowing it to reside in a dark room at 22° C. and 35-42% relative humidity until the surface is tack-free. Evaluate whether the surface is “tack-free” by swiping a nitrile glove coated finger over the samples. The sample is deemed “tack-free” when no sample transfers to the nitrile glove after swiping the surface.

Viscosity Measurements. Determine viscosity for sample compositions using a Brookfield cone and plate viscometer (Model HBDVII+P) with cone spindle CPA-52Z according to ASTM D-1084 at 23+/−2° C. Determine viscosity for the organopolysiloxanes using a Brookfield DV1 viscometer according to ASTM D-1084 at 23+/−2° C.

Sample Preparation Prepare samples using the component identified in Table 2. Combine First, Second and Third Organopolysiloxane, and filler in a 100 mL dental cup. Mix at 1000 revolutions per minute (RPM) for 20 seconds and then 2000 RPM for 45 seconds with a Dental Laboratory Mixer to form an initial mixture. Separately premix Silane with Radical Scavenger and add to the initial mixture and mix at 2000 RPM for 30 seconds. Add Photoinitiator, premixed with Carrier Liquid if used, and Condensation Catalyst and mix at 2000 RPM for 30 seconds. Package the sample in a 30 mL EFD syringe barrels and deair by centrifuging the sample in the syringe and then pushing the plunger to expel air. For “fresh” sample characterization use sample at this point of the preparation. For “aged” sample characterization vacuum package the syringe in an aluminum bag and age as described in the “Aging” procedure above.

Formulations and characterization results for the samples are in Table 2. Amounts of each component for the formulations is reported in grams. Comparative Examples (Comp Ex) and Examples (Exs) are described.

### Results

The results in Table 2 reveal that only when bisacylphosphine oxide photoinitiator is present does the compositions achieve the three-fold objective:
(1) experiencing an increase in viscosity of less than 2-times its fresh viscosity as measured according to ASTM D-1084 using by a Brookfield DVII+P viscometer with a cone spindle CPA-52Z at 23+/−2° C.; and
(2) experiencing a cure depth of at least 70%, preferably 80% or more, more preferably 90% or more relative to a freshly made identical composition when exposed to 2 Joules per square centimeter (J/cm²) UVA and UVB irradiation, and even achieve a cure depth of at least 8 mm before and after aging; and
(3) experiencing a moisture cure tack-free time of 24 hours or less.

This results is the case for various titanate catalysts. It also holds true when using a non-polar carrier liquid (toluene) or a liquid photoinitiator (Photoinitiator 1) as the carrier liquid. The data further establishes that the photoinitiator must be a bisacylphosphine oxide and that similar monoacylphosphine oxide photoinitiators (Photoinitiator 2) do not achieve the same result, see Comp Ex B and Comp Ex E for instance.

TABLE 2

| | Comp | Comp | Comp | | | Comp | Comp | | | Comp | |
|---|---|---|---|---|---|---|---|---|---|---|---|
| Component | Ex A | Ex B | Ex C | Ex 1 | Ex 2 | Ex D | Ex E | Ex 3 | Ex 4 | Ex F | Ex 5 |
| First Organopolysiloxane | 7.05 | 7.05 | 7.05 | 7.05 | 7.05 | 7.05 | 7.05 | 7.05 | 7.05 | 7.05 | 7.05 |
| Second Organopolysiloxane | 28.40 | 28.40 | 28.40 | 28.40 | 28.40 | 28.40 | 28.40 | 28.40 | 28.40 | 28.40 | 28.40 |
| Third Organopolysiloxane | 40.66 | 40.66 | 40.66 | 40.66 | 40.66 | 40.66 | 40.66 | 40.66 | 40.66 | 40.66 | 40.66 |
| Photoinitiator 1 | 1.03 | | | | 0.76 | 1.03 | | | 0.76 | 1.03 | 0.76 |
| Photoinitiator 2 | | 1.03 | | | | | 1.03 | | | | |
| Photoinitiator 3 | | | 1.03 | | | | | | | | |
| Photoinitiator 4 | | | | 1.03 | 0.27 | | | 1.03 | 0.27 | | 0.27 |
| Carrier Liquid 1 | | | | 2.5 | | | | | | | |
| Condensation Catalyst 1 | 0.10 | 0.10 | 0.10 | 0.10 | 0.10 | | | | | | |
| Condensation Catalyst 2 | | | | | | 0.10 | 0.10 | 0.10 | 0.10 | | |
| Condensation Catalyst 3 | | | | | | | | | | 0.10 | 0.10 |
| Silane | 3.74 | 3.74 | 3.74 | 3.74 | 3.74 | 3.74 | 3.74 | 3.74 | 3.74 | 3.74 | 3.74 |
| Radical Scavenger | 0.56 | 0.56 | 0.56 | 0.56 | 0.56 | 0.56 | 0.56 | 0.56 | 0.56 | 0.56 | 0.56 |
| Filler | 17.43 | 17.43 | 17.43 | 17.43 | 17.43 | 17.43 | 17.43 | 17.43 | 17.43 | 17.43 | 17.43 |

Evaluations

| | | | | | | | | | | | | |
|---|---|---|---|---|---|---|---|---|---|---|---|---|
| Viscosity (Pascal*second) | Fresh | 48.42 | 56.36 | 43.66 | 45.24 | 49.21 | 43.66 | 62.71 | 42.07 | 53.98 | 42.07 | 45.24 |
| | Aged | 174.6 | 57.94 | 132.60 | 53.98 | 75.41 | 184.90 | 50.01 | 50.01 | 63.50 | 147.60 | 56.36 |
| Cure Depth (mm) | Fresh | 2 | 10 | 3 | 12 | 9 | 5 | 10 | 17 | 16 | 3 | 16 |
| | Aged | 2 | 6 | 3 | 12 | 9 | 3 | 1 | 16 | 13 | 2.5 | 15 |
| Moisture Cure Time to Tack- | Fresh | 5-8 | 5-8 | 5-8 | 5-8 | 5-8 | 5-8 | 5-8 | 5-8 | 5-8 | 5 | 5-8 |
| Free (hours) | Aged | 3-5 | 5-8 | 3-5 | 5-8 | 5-8 | 3-5 | 5-8 | 5-8 | 5-8 | 3-5 | 5-8 |

1. A dual cure organopolysiloxane composition comprising:
a. a first organopolysiloxane comprising an average of 2 or more mercaptoalkyl groups per molecule and that is free of alkenyl functionality, free of alkoxy functionality, and has an average chemical formula:
(R¹₂R³SiO_{1/2})₂(R¹R²SiO_{2/2})ₘ(R¹₂SiO_{2/2})ₙ
where:
R¹ is independently in each occurrence, a hydrocarbyl or substituted hydrocarbyl group having from one to 20 carbon atoms;
R² is independently, in each occurrence, a mercaptoalkyl group;
R³ is independently in each occurrence selected from the options for R¹;
subscript m has an average value in a range of 2 to 1000; and
subscript n has an average value of in a range of zero to 1000;
b. a second organopolysiloxane comprising an average of one or more alkenyl group per molecule and an average of one or more hydrolysable group per molecule;
c. optionally, a third organopolysiloxane having at least two alkenyl groups per molecule and that is free of alkoxy groups;
d. a bisacylphosphine oxide photoinitiator;
e. optionally, a carrier liquid;
f. a condensation catalyst;
g. a silane with an average of 2 or more hydrolysable groups per molecule; and
h. a radical scavenger at a concentration in a range of 0.001 to 2 weight-percent relative to composition weight.

2. The composition of claim 1, wherein the composition further comprises a liquid photoinitiator.

3. (canceled)

4. (canceled)

5. The composition of claim 1, wherein the concentration of the first organopolysiloxane is sufficient to provide a molar ratio of mercaptoalkyl groups from the first organopolysiloxane to alkenyl groups from the second organopolysiloxane and, if present, third organopolysiloxane that is 0.3 or more and 5.0 or less.

6. The composition of claim 1, wherein the concentration of third organopolysiloxane is zero weight-percent or more and at the same time 80 weight-percent or less of the combined weight of second and third organopolysiloxanes.

7. The composition of claim 1, wherein the concentration of bisacylphosphine oxide photoinitiator and, if present, liquid photoinitiator is 0.01 or more and 5 or less weight-percent relative to composition weight.

8. The composition of claim 1, wherein the concentration of condensation catalyst is 0.01 or more and at the same time 5 or less weight-percent per relative to composition weight.

9. The composition of claim 1, wherein the bisacylphosphine oxide photoinitiator is bis(2,4,6-trimethylbenzoyl)-phenylphosphine oxide.

10. The composition of claim 1, wherein the second organopolysiloxane has the following structure:
(SiO_{4/2})ₓ(R^{a}₂SiO_{2/2})_{y}(R^{a}BSiO_{2/2})_{y′}(R^{a}₂BSiO_{1/2})_{z}
where:
R^{a} is independently in each occurrence selected form alkyl and aryl groups;
B is independently in each occurrence selected from alkenyl and alkoxy and alkoxy-containing groups so as to achieve an average of one or more alkenyl group and one or more alkoxy group per molecule;
x is, on average, a value of zero or more and at the same time 10 or less;
the sum of y and y′, on average, is a value of 20 or more while at the same time is 1000 or less; and
z has, on average, a value of 2 or more and at the same time is 20 or less.
